(19) United States
(12) Patent Application Publication
(10) Pub. No.: US 2022/0167644 A1
(43) Pub. Date: Jun. 2, 2022

(54) PET FOOD AND MANUFACTURING METHOD THEREOF

(71) Applicant: Rongrong CHEN, Astoria, NY (US)

(72) Inventor: Rongrong CHEN, Astoria, NY (US)

(21) Appl. No.: 17/538,969

(22) Filed: Nov. 30, 2021

(30) Foreign Application Priority Data
Nov. 30, 2020 (CN) 202011376671.X

(51) Int. Cl. A23K 10/26; A23K 20/163; A23K 10/22; A23K 40/25; A23K 50/40

(52) U.S. Cl. CPC A23K 10/26; A23K 20/163; A23K 50/40; A23K 40/25; A23K 10/22

(57) ABSTRACT

A pet food includes a first component, a second component, and a third component. The first component is made of animal skin, the second component comprises meat, the third component comprises plant starch. The first component and the third component are wound or attached to each other, and the second component is disposed or filled between the first component and the third component. Manufacturing methods for the pet food are also provided.

### CROSS-REFERENCE TO RELATED APPLICATION

This application claims priority to Chinese patent application No. 202011376671.X, filed Nov. 30, 2020, the disclosure of which is incorporated herein by reference in its entirety.

### BACKGROUND

The invention relates to the technical field of pet food, in particular to pet chews and manufacturing methods thereof.

With China's fast-paced economic development, the living standards of the domestic people continue to improve. Raising and care of pets is also on the rise, and the pet food industry has been developing rapidly. Pet food snacks provide pets with the nutrients they need for growth and development. Currently, the commonly known dog chew is made with two or three layers of pigskin or cowhide, which can help pets grind teeth. However, only a small amount is ingested during the chewing process of pets, and a large section remains, which becomes unattractive to the pets and routinely thrown away by the owners. Also, too much intake of cowhide or pigskin material will cause food jams for the pets and affect the gastrointestinal absorption.

At present, traditional dog chews are only be used for pets' chewing and teeth grinding. They have poor taste and little micronutrients, and do not stimulate pets' appetite. There is a lot of waste, too.

In recent years, many plant-based pet snack products have been launched on the market. Some enticing components and trace nutrients are added to the snack products to increase their allure to pets. However, due to the inadequate overall strength of pet snacks, a pet will usually chew up and swallow the snacks in a short time, thus the effect of teeth grinding of the pets is not fully realized.

### SUMMARY

To overcome the shortcomings of the prior art, the present invention provides a pet food and a manufacturing method thereof, which can help pets grind teeth, is convenient for pets to ingest, and can effectively improve the food jam problems, and at the same time provides good nutrition.

To attain the above objectives, the present invention provides a pet food, which includes a first component, a second component, and a third component, wherein the first component is made of animal skin or collagen, the second component comprises meat, the third component comprises plant starch, and wherein the first component and the third component are wound or attached to each other, and the second component is disposed or filled between the first component and the third component.

In some embodiments, the first, second and third components are all in a rod shape or a strip shape, and the first, second, and third components are wound (e.g., braided) to form at least one composite body, which may have an overall elongated shape. In some embodiments, at least one of the first component and the third component is thicker than the second component.

In some embodiments, the first component and the third component are each in a rod shape or a belt shape, the two ends of the first component are wound to two ends of the third component respectively, and a middle section of the first component is attached to a middle section of the third component, and the second component is in a puree form attached to an outer surface of the first component and that of the third component.

The present invention also provides a method for manufacturing a pet food product, which comprises:

(a) manufacturing the first component, which comprises:
washing animal skin with clean water and bleaching it, drying it on a support, and cutting the dried animal skin, to thereby obtain the first component;

(b) manufacturing the second component, which comprises:
selecting a main ingredient from fresh chicken meat, fresh beef, fresh lamb, fresh pork, fresh duck meat, fresh fish, and mixing 75-85 parts of the main ingredient, 7.5-8.5 parts of vegetable starch, 4.7-5.3 parts of gelatin, 5.2-5.8 parts of glycerin, 0.9-1.1 parts of food coloring, and 0.5 parts of potassium sorbate in a blender for 15-20 minutes, and then passing the mixture through a cooking machine to cook the mixture for 10-15 minutes, and then using an extruder to squeeze the cooked mixture at 70-100° C. into round strips or flat strips, to thereby obtain the second component;

(c) manufacturing the third component, which comprises:
mixing the following ingredients: 10-16% of corn starch, 6-10% of potato flour, 8-12% of rice flour, 11-21% of fresh chicken meat, 4-6% of chicken powder, 5-7% of soy protein isolate, 4-6% of pea flour, 3-4.5% of cellulose, 8-11.5% of glycerin, 6-8% of cheese, 4-5.8% of gelatin, 0.9-1.05% of shortening, 1.8-2.1% of hemp seed oil, 3.8-4.3% of yeast powder, 1.9-2.2% of xanthan gum, 1.15-1.22% of food coloring, and 0.8% of potassium sorbate into a blender for 20-30 minutes, wherein all the percentages are based on the total weight of these ingredients,
passing the mixture to a cooking machine to cook the mixture for 15-30 minutes, and
using an extruder to extrude the cooked mixture at 60-100° C. into round or flat strips, to thereby obtain the third component;

(d) twisting or winding the first, second and third components into a composite product of a target shape, drying the composite product at 45-55° C. for 10-15 hours, and sterilizing it at 80-90° C. for 30 minutes.

The present invention further provides a method for manufacturing a pet food product, which comprises:

(a) manufacturing the first component, which comprises:
washing an animal skin with clean water, bleaching it, drying it on a support, cutting the dried animal skin, to thereby obtain the first component;

(b) manufacturing the second component, which comprises:
selecting a main ingredient from fresh chicken meat, fresh beef, fresh lamb, fresh pork, fresh duck meat, fresh fish, grinding the main ingredient in a grinder to obtain mashed main ingredient, mixing 70-76 parts of the mashed main ingredient, 18-21 parts of wheat flour, 1.8-2.1 parts of gelatin, 3.9-4.6 parts of glycerin, and 0.5 parts of potassium sorbate into a mixing equipment to obtain the second component in a puree form;

(c) manufacturing the third component, which comprises:
mixing the following ingredients: 10-16% of corn starch, 6-10% of potato flour, 8-12% of rice flour, 11-21% of fresh chicken meat, 4-6% of chicken powder, 5-7% of soy protein isolate, 4-6% of pea flour, 3-4.5% of cellulose, 8-11.5% of glycerin, 6-8% of cheese, 4-5.8% of gelatin, 0.9-1.05% of shortening, 1.8-2.1% of hemp seed oil, 3.8-4.3% of yeast powder, 1.9-2.2% of xanthan gum, 1.15-1.22% of food coloring, and 0.8% of potassium sorbate into a blender for 20-30 minutes, wherein all the percentages are based on the total weight of these ingredients,
passing the mixture to a cooking machine to cook the mixture for 15-30 minutes, and
using an extruder to extrude the cooked mixture at 60-100° C. into round thin strips, square strips, or flat strips, to thereby obtain the third component;

(d) winding and knotting the two ends of the first component with the two ends of the third component respectively, and attaching a middle section of the first component to a middle section of the third component, and coating the second component on the outer surface of the first component and the third component, to thereby form a composite product, drying the composite product at 50-70° C. for 10-20 hours, and sterilizing it at 80-90° C. for 30 minutes.

The beneficial effect of the invention includes: the pet food is manufactured with three components, where the first component made of animal skin with good strength, which can assist the animal in grinding teeth. The second component containing animal meet can entice pets and provides a certain amount of protein, and is more convenient for pets to consume. At the same time, only a small part of the second component is exposed, which is helpful to reduce overall waste, and can last longer when chewed by pets. The third component made of plant starch can increase the nutrients of trace elements to nourish the pets. At the same time, the first component and the third component are combined to ensure the overall strength, and make the pet consumed less quickly. The pet food not only is good for grinding teeth, easy to ingest, but also helpful to alleviate food jams. The pet food can be made into a variety of shapes to meet market needs. The addition of hemp seed oil can help calm the pets. Further, by including cheese, the pet food has improved nutritional content.

### BRIEF DESCRIPTION OF THE DRAWINGS

FIG. 1 is a schematic diagram of the structure of a first embodiment of the present invention.

FIG. 2 is a schematic diagram of the structure of a second embodiment of the present invention.

### DETAILED DESCRIPTION OF SPECIFIC EMBODIMENTS

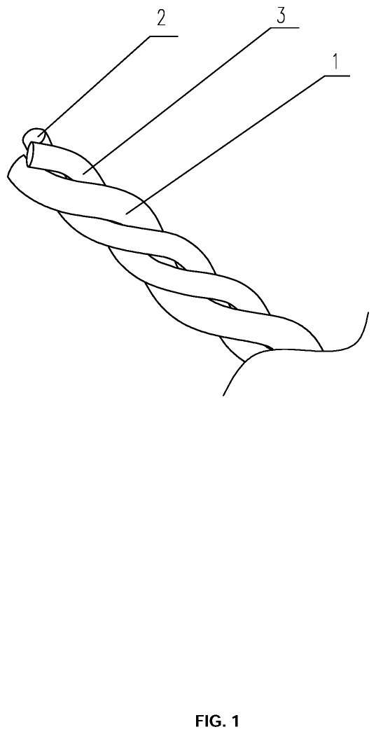

As shown in FIG. 1, which schematically illustrates the structure of a first embodiment of a pet food of the present invention, which includes a first component 1, a second component 2 and a third component 3. The first component 1 is made of animal skin or collagen, the second component 2 is made of meat, the third component 3 is made of plant starch. The first component 1 and the third component 3 are wound together, and the second component 2 is disposed or filled between the first component 1 and the third component 3.

As a further arrangement of the present embodiment, the first, second, and third components 1, 2 and 3 are all in a rod shape or a belt shape, and the first, second, and third components are twisted to form at least one composite body, and at least one of the first component 1 and the third component 3 is thicker than the second component 3.

As a further arrangement of this embodiment, the first component and the third component can be in a rod shape or a belt shape, the two ends of the first component are wound to two ends of the third component respectively, and a middle section of the first component is attached to a middle section of the third component. The second component is in a puree form attached to an outer surface of the first component and that of the third component.

The embodiment can be manufactured as follows. The first component is manufactured by washing an animal skin with clean water and bleaching, drying on a support, and cutting the dried animal skin. The second component is manufactured by: selecting a main ingredient from fresh chicken meat, fresh beef, fresh lamb, fresh pork, fresh duck meat, fresh fish, and mixing 75-85 parts of the main ingredient, 7.5-8.5 parts of vegetable starch, 4.7-5.3 parts of gelatin, 5.2-5.8 parts of glycerin, 0.9-1.1 parts of food coloring, and 0.5 parts of potassium sorbate in a blender for 15-20 minutes, and then passing the mixture through a cooking machine to cook the mixture for 10-15 minutes, and then using an extruder to squeeze the cooked mixture at 70-100° C. into round strips or flat strips, to thereby obtain the second component. The third component is manufactured by: mixing the following ingredients: 10-16% of corn starch, 6-10% of potato flour, 8-12% of rice flour, 11-21% of fresh chicken meat, 4-6% of chicken powder, 5-7% of soy protein isolate, 4-6% of pea flour, 3-4.5% of cellulose, 8-11.5% of glycerin, 6-8% of cheese, 4-5.8% of gelatin, 0.9-1.05% of shortening, 1.8-2.1% of hemp seed oil, 3.8-4.3% of yeast powder, 1.9-2.2% of xanthan gum, 1.15-1.22% of food coloring, and 0.8% of potassium sorbate into a blender for 20-30 minutes, wherein all the percentages are based on the total weight of these ingredients, passing the mixture to a cooking machine to cook the mixture for 15-30 minutes, and using an extruder to extrude the cooked mixture at 60-100° C. into round strips or flat strips, to thereby obtain the third component. The first, second and third components are then twisted to form a composite product of a desired shape, dried at 45-55° C. for 10-15 hours, and sterilized at 80-90° C. for 30 minutes.

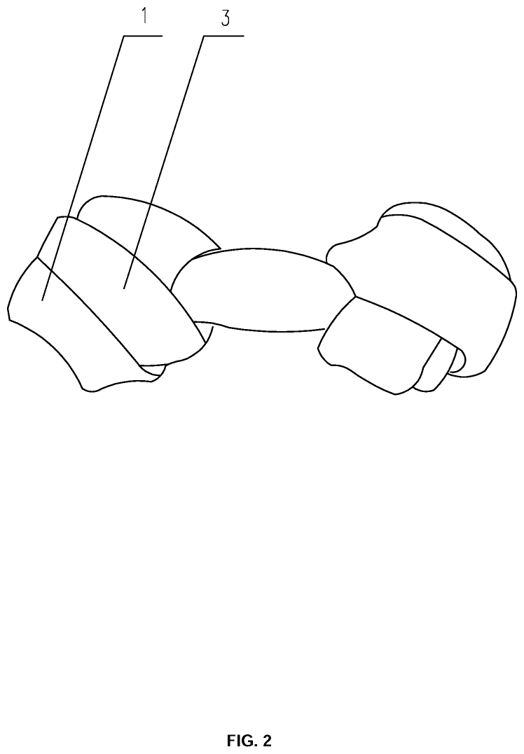

The second embodiment of the present invention is shown in FIG. 2, which is a pet food that includes a first component 1, a second component 2 and a third component 3, where the first component 1 is made of animal skin or collagen, the second component 2 is made of meat, the third component 3 is made of plant starch, the first component 1 and the third component 3 are wound or attached together. The second component 2 is filled between the component 1 and the third component 3.

As a further arrangement of this embodiment, the first component 1 and the third component 3 are each in a rod shape or a belt shape, and two ends of the first component 1 are entangled with the two ends of the third component 3 respectively. The middle section of the first component 1 is attached to the middle section of the third component 3, and the second component 2 is arranged in a puree form and attached to the outside of the first component 1 and the third component 3.

This embodiment can be manufactured as follows. The first component can be manufactured by washing an animal skin with clean water, bleaching, drying on a support, and cutting the dried animal skin, to thereby obtain the first component. The second component can be manufactured by: selecting a main ingredient from fresh chicken meat, fresh beef, fresh lamb, fresh pork, fresh duck meat, fresh fish, grinding the main ingredient in a grinder to obtain mashed main ingredient, mixing 70-76 parts of the mashed main ingredient, 18-21 parts of wheat flour, 1.8-2.1 parts of gelatin, 3.9-4.6 parts of glycerin, and 0.5 parts of potassium sorbate into a mixing equipment to obtain the second component in a puree form. The third component can be manufactured by: mixing the following ingredients: 10-16% of corn starch, 6-10% of potato flour, 8-12% of rice flour, 11-21% of fresh chicken meat, 4-6% of chicken powder, 5-7% of soy protein isolate, 4-6% of pea flour, 3-4.5% of cellulose, 8-11.5% of glycerin, 6-8% of cheese, 4-5.8% of gelatin, 0.9-1.05% of shortening, 1.8-2.1% of hemp seed oil, 3.8-4.3% of yeast powder, 1.9-2.2% of xanthan gum, 1.15-1.22% of food coloring, and 0.8% of potassium sorbate into a blender for 20-30 minutes, where all the percentages are based on the total weight of these ingredients; passing the mixture to a cooking machine to cook the mixture for 15-30 minutes; and using an extruder to extrude the cooked mixture at 60-100° C. into round strips or flat strips, to thereby obtain the third component. The two ends of the first component are wound and knotted with the two ends of the third component respectively, and the middle section of the first component are attached with the middle section of the third component, and the second component is coated onto the outer surface of the first component and the third component. In this manner, a composite product is made. The composite product is then dried at 50-70° C. for 10-20 hours, and sterilized at 80-90° C. for 30 minutes.

The above examples are only specific embodiments of the present invention. Routine changes and substitutions made by those skilled in the art within the scope of the technical solution of the present invention are encompassed in the protection scope of the present invention.

1. A pet food product comprising:
a first component, a second component, and a third component,
wherein the first component is made of animal skin or collagen, the second component comprises meat, the third component comprises plant starch, and
wherein the first component and the third component are wound or attached to each other, and the second component is filled between the first component and the third component.

2. The pet food product according to claim 1, wherein the first, second and third components are each in a rod shape or a belt shape, and the first, second, and third components are wound to form at least one composite body, and at least one of the first component and the third component is thicker than the second component.

3. The pet food product according to claim 1, wherein the first component and the third component are each in a rod shape or a belt shape, the two ends of the first component are wound to two ends of the third component respectively, and a middle section of the first component is attached to a middle section of the third component, and the second component is in a puree form attached to an outer surface of the first component and that of the third component.

4. A method for manufacturing a pet food product according to claim 1, comprising:
(a) manufacturing the first component, which comprises:
washing an animal skin with clean water and bleaching it, drying it on a support, and cutting the dried animal skin, to thereby obtain the first component;
(b) manufacturing the second component, which comprises:
selecting a main ingredient from fresh chicken meat, fresh beef, fresh lamb, fresh pork, fresh duck meat, fresh fish, and mixing 75-85 parts of the main ingredient, 7.5-8.5 parts of vegetable starch, 4.7-5.3 parts of gelatin, 5.2-5.8 parts of glycerin, 0.9-1.1 parts of food coloring, and 0.5 parts of potassium sorbate in a blender for 15-20 minutes, and then passing the mixture through a cooking machine to cook the mixture for 10-15 minutes, and then using an extruder to squeeze the cooked mixture at 70-100° C. into round strips or flat strips, to thereby obtain the second component;
(c) manufacturing the third component, which comprises:
mixing the following ingredients: 10-16% of corn starch, 6-10% of potato flour, 8-12% of rice flour, 11-21% of fresh chicken meat, 4-6% of chicken powder, 5-7% of soy protein isolate, 4-6% of pea flour, 3-4.5% of cellulose, 8-11.5% of glycerin, 6-8% of cheese, 4-5.8% of gelatin, 0.9-1.05% of shortening, 1.8-2.1% of hemp seed oil, 3.8-4.3% of yeast powder, 1.9-2.2% of xanthan gum, 1.15-1.22% of food coloring, and 0.8% of potassium sorbate into a blender for 20-30 minutes, wherein all the percentages are based on the total weight of these ingredients,
passing the mixture to a cooking machine to cook the mixture for 15-30 minutes, and
using an extruder to extrude the cooked mixture at 60-100° C. into round strips or flat strips, to thereby obtain the third component; and
(d) twisting or winding the first, second and third components into a composite product of a target shape, drying the composite product at 45-55° C. for 10-15 hours, and sterilizing it at 80-90° C. for 30 minutes.

5. A method for manufacturing a pet food product according to claim 2, comprising:
(a) manufacturing the first component, which comprises:
washing an animal skin with clean water and bleaching it, drying it on a support, and cutting the dried animal skin, to thereby obtain the first component;
(b) manufacturing the second component, which comprises:
selecting a main ingredient from fresh chicken meat, fresh beef, fresh lamb, fresh pork, fresh duck meat, fresh fish, and mixing 75-85 parts of the main ingredient, 7.5-8.5 parts of vegetable starch, 4.7-5.3 parts of gelatin, 5.2-5.8 parts of glycerin, 0.9-1.1 parts of food coloring, and 0.5 parts of potassium sorbate in a blender for 15-20 minutes, and then passing the mixture through a cooking machine to cook the mixture for 10-15 minutes, and then using an extruder to squeeze the cooked mixture at 70-100° C. into round strips or flat strips, to thereby obtain the second component;
(c) manufacturing the third component, which comprises:
mixing the following ingredients: 10-16% of corn starch, 6-10% of potato flour, 8-12% of rice flour, 11-21% of fresh chicken meat, 4-6% of chicken powder, 5-7% of soy protein isolate, 4-6% of pea flour, 3-4.5% of cellulose, 8-11.5% of glycerin, 6-8% of cheese, 4-5.8% of gelatin, 0.9-1.05% of shortening, 1.8-2.1% of hemp seed oil, 3.8-4.3% of yeast powder, 1.9-2.2% of xanthan gum, 1.15-1.22% of food coloring, and 0.8% of potassium sorbate into a blender for 20-30 minutes, wherein all the percentages are based on the total weight of these ingredients,
passing the mixture to a cooking machine to cook the mixture for 15-30 minutes, and
using an extruder to extrude the cooked mixture at 60-100° C. into round strips or flat strips, to thereby obtain the third component; and
(d) twisting or winding the first, second and third components into a composite product of a target shape, drying the composite product at 45-55° C. for 10-15 hours, and sterilizing it at 80-90° C. for 30 minutes.

6. A method for manufacturing a pet food according to claim 3, comprising:
(a) manufacturing the first component, which comprises:
washing an animal skin with clean water, bleaching it, drying it on a support, cutting the dried animal skin, to thereby obtain the first component;
(b) manufacturing the second component, which comprises:
selecting a main ingredient from fresh chicken meat, fresh beef, fresh lamb, fresh pork, fresh duck meat, fresh fish, grinding the main ingredient in a grinder to obtain mashed main ingredient, mixing 70-76 parts of the mashed main ingredient, 18-21 parts of wheat flour, 1.8-2.1 parts of gelatin, 3.9-4.6 parts of glycerin, and 0.5 parts of potassium sorbate into a mixing equipment to obtain the second component in a puree form;
(c) manufacturing the third component, which comprises:
mixing the following ingredients: 10-16% of corn starch, 6-10% of potato flour, 8-12% of rice flour, 11-21% of fresh chicken meat, 4-6% of chicken powder, 5-7% of soy protein isolate, 4-6% of pea flour, 3-4.5% of cellulose, 8-11.5% of glycerin, 6-8% of cheese, 4-5.8% of gelatin, 0.9-1.05% of shortening, 1.8-2.1% of hemp seed oil, 3.8-4.3% of yeast powder, 1.9-2.2% of xanthan gum, 1.15-1.22% of food coloring, and 0.8% of potassium sorbate into a blender for 20-30 minutes, wherein all the percentages are based on the total weight of these ingredients,
passing the mixture to a cooking machine to cook the mixture for 15-30 minutes, and
using an extruder to extrude the cooked mixture at 60-100° C. into round strips or flat strips, to thereby obtain the third component; and
(d) winding and knotting the two ends of the first component with the two ends of the third component respectively, attaching a middle section of the first component to a middle section of the third component, and coating the second component on the outer surface of the first component and the third component, to thereby form a composite product, drying the composite product at 50-70° C. for 10-20 hours, and sterilizing it at 80-90° C. for 30 minutes.
